(19) United States
(12) Patent Application Publication
(10) Pub. No.: US 2011/0310126 A1
(43) Pub. Date: Dec. 22, 2011

(54) METHOD AND SYSTEM FOR INTERACTING WITH DATASETS FOR DISPLAY

(76) Inventors: Emil Markov Georgiev, Hartland, WI (US); Erik Paul Kemper, Franklin, WI (US); Ryan Jerome Ramos, Greenfield, WI (US); Ludovic Avot, Crossy Siseiwe (FR)

(21) Appl. No.: 12/820,919

(22) Filed: Jun. 22, 2010

(51) Int. Cl. G06F 3/041; G09G 5/00

(52) U.S. Cl. 345/660; 345/173

(57) ABSTRACT

Methods and systems for interacting with datasets for display are provided. One method includes displaying information on a display having a surface viewable by a user and receiving a user input at a surface of a multi-touch sensitive device. The surface of the multi-touch sensitive device is a different surface than the surface of the display viewable by the user. The method further includes manipulating the displayed information in response to the received user input.

### BACKGROUND OF THE INVENTION

The subject matter disclosed herein relates generally to methods and systems for interacting with datasets, and more particularly interacting with displayed datasets including reviewing, manipulating and/or creating datasets for display.

Professional users who interact with datasets (e.g., multimedia datasets) on a daily basis, such as radiologists that review patient data, can interact with the datasets (e.g., review, manipulate and create) for long periods of time, which may be eight to twelve hours a day or longer. The long periods of interaction can create challenges and issues for the user. For example, these types of users may experience repetitive stress hand injuries from prolonged use of a mouse and overall discomfort if the workplace environment is not properly ergonomically engineered. Additionally, these users may experience difficulties keeping visual focus on the work due to the sometimes demanding nature of the interaction devices that require shifting of the visual focus or complete context switches to enable navigation.

The nature of the human-computerized system interactions are dictated by the nature of the available input/output capabilities. In conventional systems, these interactions do not match and/or mimic the natural ways humans typically interact. For example, commercial systems that use more natural multi-touch input methods include handheld devices or interactive surfaces. In both the handheld and interactive surface applications, the input device is also the visualization device. In both of these systems, the user interaction patterns are not conducive to prolonged daily use with constant interactions, such as are encountered with certain professional users (e.g., a reviewing radiologist). Moreover, these systems do not support the repetitive and prolonged nature of the daily tasks for prolonged users.

### BRIEF DESCRIPTION OF THE INVENTION

In accordance with various embodiments, a method for interacting with displayed information is provided. The method includes displaying information on a display having a surface viewable by a user and receiving a user input at a surface of a multi-touch sensitive device. The surface of the multi-touch sensitive device is a different surface than the surface of the display viewable by the user. The method further includes manipulating the displayed information in response to the received user input.

In accordance with other various embodiments, a workstation is provided that includes at least one display oriented for viewing by a user and displaying information on a surface of the display. The workstation further includes a multi-touch sensitive device having a screen with a surface location different than the surface of the display. The multi-touch sensitive device is configured to detect contact of the screen surface by one or more fingers of a user, with the user contact corresponding to a user input. The workstation also includes a processor configured to manipulate the displayed information in response to the received user input.

In accordance with yet other various embodiments, a user interface is provided that includes a multi-touch sensitive device having an input surface configured to detect user touch inputs. The user interface further includes a display surface configured to display information for viewing, wherein the input surface and the display surface are not the same surface, and the displayed information is manipulated based on the user touch inputs.

### BRIEF DESCRIPTION OF THE DRAWINGS

FIG. 1 is a block diagram illustrating a user interface formed in accordance with various embodiments provided as part of a workstation.

FIG. 2 is a block diagram illustrating a configuration of a user interface formed in accordance with various embodiments.

FIG. 3 is a diagram illustrating the operation of a user interface formed in accordance with various embodiments.

FIG. 4 is a simplified block diagram of a user interface formed in accordance with various embodiments.

FIG. 5 is a flowchart of a method for interacting with displayed information using a touch sensitive display in accordance with various embodiments.

FIG. 6 is a flowchart of another method for interacting with displayed information using a touch sensitive display in accordance with various embodiments.

FIG. 7 is a diagram illustrating a user interface configured with displays in accordance with one embodiment.

FIG. 8 is a diagram illustrating a user interface configured with displays in accordance with another embodiment.

FIG. 9 is a diagram illustrating a user interface configured with displays in accordance with another embodiment.

FIG. 10 is diagram of a display illustrating graphical indicators displayed in accordance with various embodiments.

### DETAILED DESCRIPTION OF THE INVENTION

The foregoing summary, as well as the following detailed description of certain embodiments will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Various embodiments provide a system and method for interaction with datasets, such as multimedia datasets. The interaction in some embodiments is provided using a multi-touch sensitive input device and visualization on one or more different surfaces, for example, separate displays or surfaces at different locations on the same device. The various embodiments may be configured as a workstation that allows a user to review, manipulate and/or create datasets for display, such as multimedia datasets. For example, the workstation may be a Picture Archiving and Communication System (PACS) workstation, which may be configured for a particular application, such as a Radiology Information System/Picture Archiving and Communication System (RIS/PACS) workstation, allowing for image and information management in radiology.

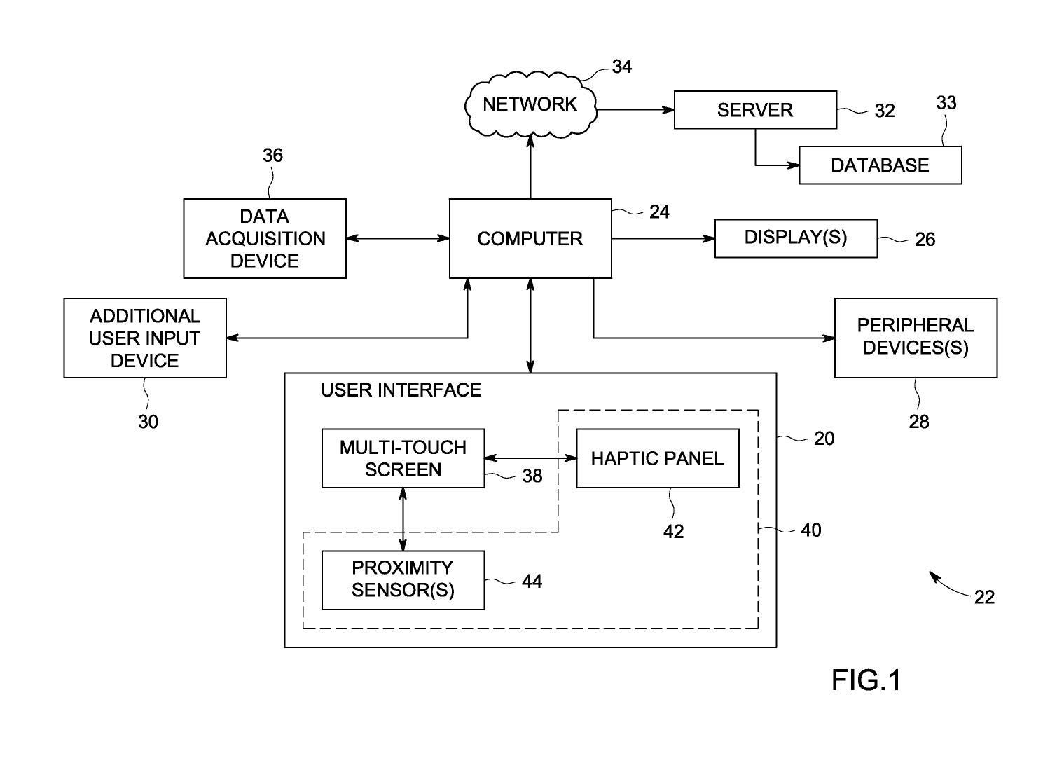

FIG. 1 illustrates a user interface 20 formed in accordance with various embodiments that may be part of a workstation 22. The workstation 22 generally includes a computer 24 or other processor/processing machine that receives user inputs via the user interface 20 as described in more detail below. The computer 24 is connected to one or more displays 26 for displaying information, such as images and data. In various embodiments, the content being displayed on one or more of the displays 26, such as one or more monitors, is similarly displayed on a screen of the user interface 20 such that a user may use touch commands to control the display and manipulation of the information displayed on the displays 26.

One or more peripheral devices 28 may be connected to the computer 24. The peripheral devices 28 may include, for example, an external reading/writing device (e.g., CD or DVD drive) for receiving a computer readable medium, a printer, etc. One or more additional user input devices 30 also may be provided for receiving a user input. For example, the additional user input devices 30 may include a keyboard, keypad, mouse, trackball, joystick or other physical input device. Accordingly, a user input may be received by the user interface 20 and optionally the additional user input device(s) 30, which may be non-touch sensitive input devices.

The computer 24 also may be connected to a server 32 via a network 34. The server 32 may store data in one or more databases 33. The network 34 may be any type of network, for example, a local area network (LAN), such as within a hospital. However, it should be noted that the network 32 may be a local network, such as an intranet, or may be the World Wide Web or other internet. Accordingly, the computer 24 may access and store information or data locally (e.g., in a local memory of the computer 24, such as a hard drive) or remotely at the server 32.

The workstation 22 also optionally be connected to a data acquisition device 36. The data acquisition device 36 may be located locally and connected to the workstation 22 or may be located remote from the data acquisition device 36. For example, the workstation 22 may form part of the data acquisition device 36, may be located in the same room or a different room than the data acquisition device 36 or may be located in a different facility than the data acquisition device 36. In some embodiments, the data acquisition device 36 is an imaging device or scanner, such as a diagnostic medical imaging device. For example, the data acquisition device 36 may be an x-ray scanner or computed tomography (CT) scanner, among other types of medical imaging devices.

In various embodiments, the user interface 20 is configured to allow interaction, interfacing and/or control of displayed information or data, for example, review, manipulation and creation of displayed information or data based on multiple user inputs (e.g., using multiple fingers of a user), which may be performed separately or concurrently. It should be noted that manipulating information or data, such as manipulating displayed information or data can include any type of review, modification, creation or other interaction with the displayed information or data.

The user interface generally includes a multi-touch sensitive device, for example, a multi-touch screen 38 that is capable of sensing or detecting contact of the screen surface by a user to thereby receive a user input. Thus, all or at least a portion of the multi-touch screen 38 includes one or more touch sensitive areas that in various embodiments allow for user interaction with the displayed information. The multi-touch screen 38 is any touch sensitive device, particularly a device having a screen and that includes one or more portions that are able to detect the location of a user's touch on the multi-touch screen 38. It should be noted that various types of touch technologies are contemplated for use in the multi-touch screen 38, including but not limited to touch sensitive elements such as capacitive sensors, membrane switches, and infrared detectors.

The user interface 20 also includes a user guidance system 40, all or a part of which may form part of or be separate from the multi-touch screen 38. The guidance system 40 generally facilitates a user's interaction with the multi-touch screen 38 to provide, for example, guidance information with respect to manipulating displayed data. In one embodiment, the guidance system 40 includes a haptic panel 42 and one or more proximity sensors 44.

The haptic panel 42 may operate in combination with the touch sensitive multi-touch screen 38 to provide haptic response or feedback to a user, which may be localized to an area of the multi-touch screen 38 sensing the user touch. The haptic panel 42 may include a plurality of piezoelectric actuators arranged in a pattern that provides tactile feedback, such as vibrational feedback at and/or in proximity to the user's touch point of the multi-touch screen 38. One or more proximity sensor(s) 44 also may be used in combination with the haptic panel 42 to guide a user when interacting with the multi-touch screen 38. For example, one or more infrared proximity sensors may be provided as part of the haptic panel 42 (e.g., below the multi-touch screen 38) or separate from the haptic panel 42, such as in a separate panel or in separate units. The proximity sensor(s) 44 may be any type of sensor that detects the presence of a user's finger or other body part or object (e.g., stylus) before contact with the multi-touch screen 38 is made. For example, the proximity sensor(s) 44 may be configured to detect a user's finger prior to contact of the finger with the multi-touch screen 38. The proximity sensor(s) 44 may detect the presence of one or more fingers at a predetermined distance from (e.g., above) the multi-touch screen 38. A visual indication of the detected finger(s) also may be displayed to a user, for example, on the display(s) 26 as described in more detail herein.

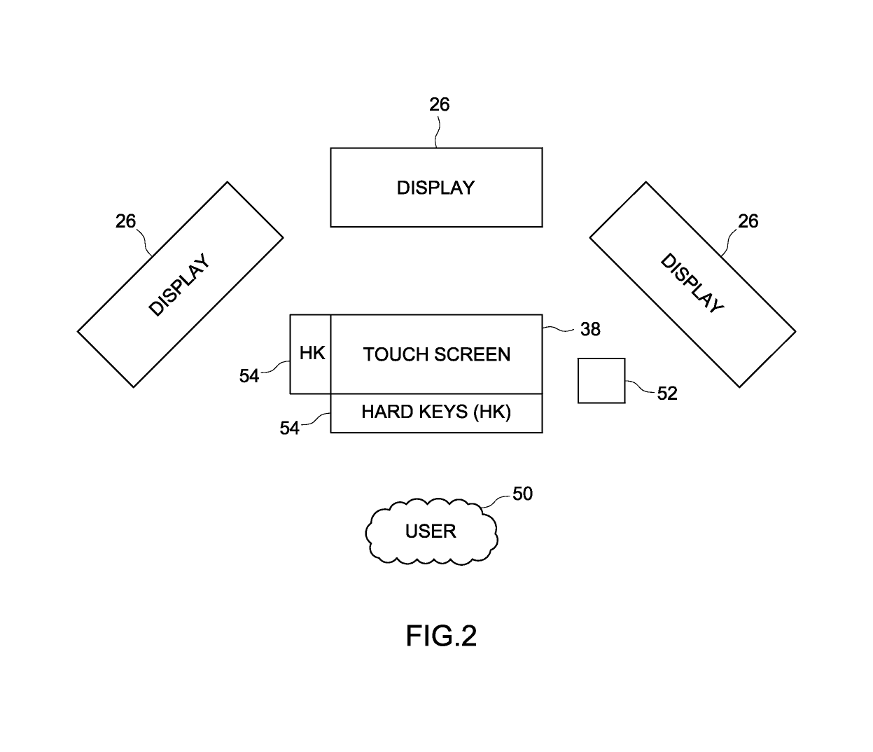

Thus, a user is guided during interaction, such as review, manipulation and/or creation of displayed information while operating the multi-touch screen 38. The various embodiments, including the user interface 20 may be provided for use in a medical setting, for example, for use by a reviewing radiologist. In such a setting, or in other settings, the multi-touch screen 38 and displays 26 may be provided as illustrated in FIG. 2. It should be noted that the system components are represented generally as blocks in FIG. 2 (illustrating a diagrammatic top view), but may be provided in different configurations. As shown, the various components are provided in some embodiments such that the plurality of displays 26 are arranged with the display surfaces positioned vertically (or substantially vertically) and arranged around the area of primary visual focus of a user 50, which in this example is a radiologist. The multi-touch screen 38 is positioned horizontally (or substantially horizontally).

The input devices include a graphical multi-touch screen input device, illustrated as the multi-touch screen 38, as well as additional input devices, for example, a mouse 52 and hard keys 54 that are physically depressible by the user 50. It should be noted that the hard keys 54 may form part of, be connected to, placed adjacent or be separate from the multi-touch screen 38. Thus, the input devices provide both touch screen input and/or physical movement input. It should be noted that other input devices as described herein additionally or alternatively may be provided. Further, non-tactile user inputs optionally may be provided in any suitable manner, such as a voice input and text to speech interfacing device (e.g., a headset or microphone/speakers).

The multi-touch screen 38 in at least one embodiment is positioned in front of the displays 26 oriented similar to a typical keyboard, such as is positioned in a radiology review system. Alternatively or additionally, the multi-touch screen 38 may be movable to configurations or orientations that support ergonomic utilization, such as for use during prolonged periods of time (e.g., up to eight to twelve hours a day). Thus, in some embodiments, the multi-touch screen 38 may replace a keyboard used with the displays 26. In other embodiments, a separate keyboard may be provided as described in more detail herein.

In operation, the user guidance system 40 (illustrated in FIG. 1) associated with the multi-touch screen 38, provides proximity sensing/visualization and/or haptic sensing. The user guidance system 40 may be on all the time or selectively switched off (e.g., one or both of the proximity sensing/visualization and/or haptic sensing at the same time) to support, for example, different operation modes, user preferences, level of user expertise, among others. In some embodiments, depending on the workflow needs or wants, the multi-touch screen 38 may be configured to display and manipulate text and/or images in multiple windows/panes, as an electronic keyboard and other graphical user interface (GUI) controls to define a multi-touch surface. The GUI may include, for example, virtual controls or user selectable elements operable with the multi-touch screen 38.

Before each touch contact, the proximity of the radiologist's finger(s) is detected by the proximity sensor(s) 44 (e.g., infrared near surface proximity sensing device) and is displayed on a screen of one or more of the displays 26 as a means to guide the user to the appropriate touch. In some embodiments, a graphical indicator (e.g., a circle) is displayed representing the region in proximity to which a user's finger is detected. This graphical indicator allows a user to confirm or adjust different touches or motions using the multi-touch screen 38. The multi-touch screen 38 in combination with the proximity sensing/visualization and/or haptic sensing allows a user in various embodiments to have a visual focus on the displays 26.

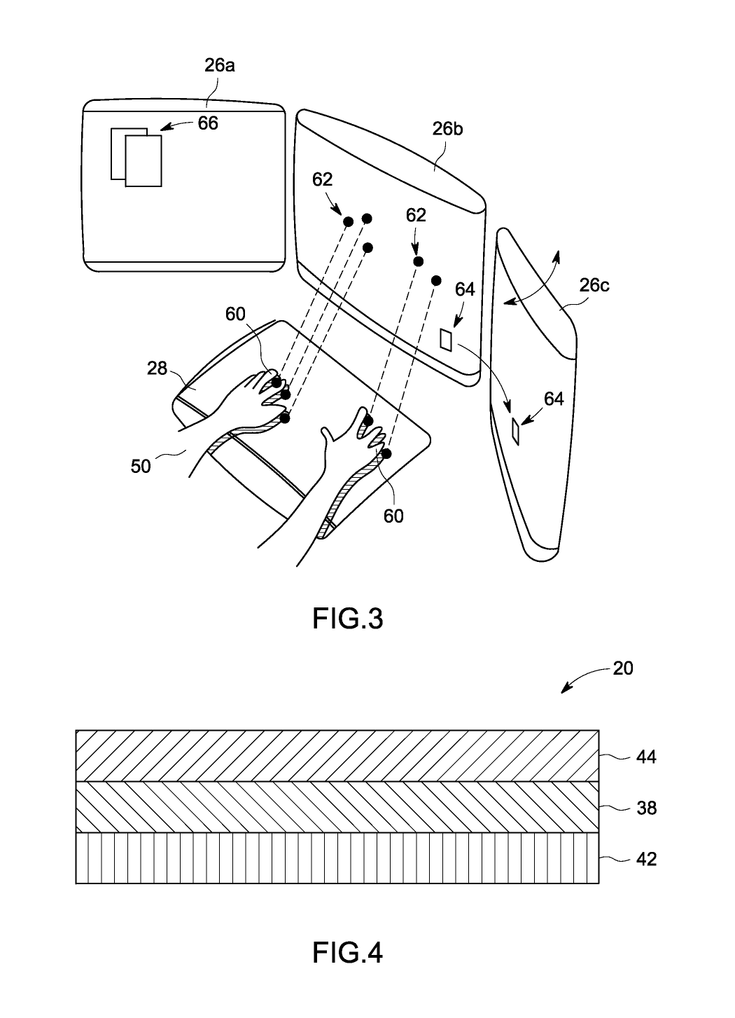

Thus, as shown in FIG. 3, fingers 60 of a user 50 may be sensed prior to contacting the multi-touch screen 38 and the corresponding locations 62 identified on one of the displays 26b. For example, a colored circle or ring may be displayed corresponding to each of the user's fingers 60. It should be noted that the multi-touch screen 38 in the illustrated embodiment is a touch screen having the same display arrangement (e.g., same displayed component configuration) as the display 26b such that movement or the user's fingers 60 along or above the multi-touch screen 38 corresponds directly to displayed movement on the display 26b. Thus, in the some embodiments, the information displayed on the multi-touch screen 38 is the same information as displayed on the display 26b and displayed in the same locations and orientations.

Additionally, a displayed object 64 may be moved, such as along the display 26b and/or to another display 26c by user touch movement on the multi-touch screen 38. The object 64 in the radiology review application may be one or more x-ray images or files. Thus, the multi-touch screen 38 may correspond to the display 26b or the display 26c (or both). Accordingly, in some embodiments, as the user manipulates information on different screens, the information on the multi-touch screen 38 switches or scrolls accordingly. In other embodiments, tapping on the multi-touch screen 38 switches association of the multi-touch screen 38 to a different display 26a-26c. In still other embodiments, the information displayed on the multi-touch screen 38 may correspond to the information displayed on all the displays 26a-26c. It should be noted that although examples may be given herein with respect to a particular display or action, similar actions may be performed in connection with any of the screens or displays. For example, similar operations may be performed on one or more windows 66 (or displayed panels).

It should be appreciated that the input device of various embodiments, such as the user interface 20 illustrated in FIG. 4, includes a plurality of components. In particular, the user interface 20 includes the multi-touch screen 38, haptic panel 42 and proximity sensor(s) 44. It should be noted that FIG. 4 is simply illustrating the components forming the user interface 20 and not any particular layers, arrangement or hierarchical structure of the user interface 20.

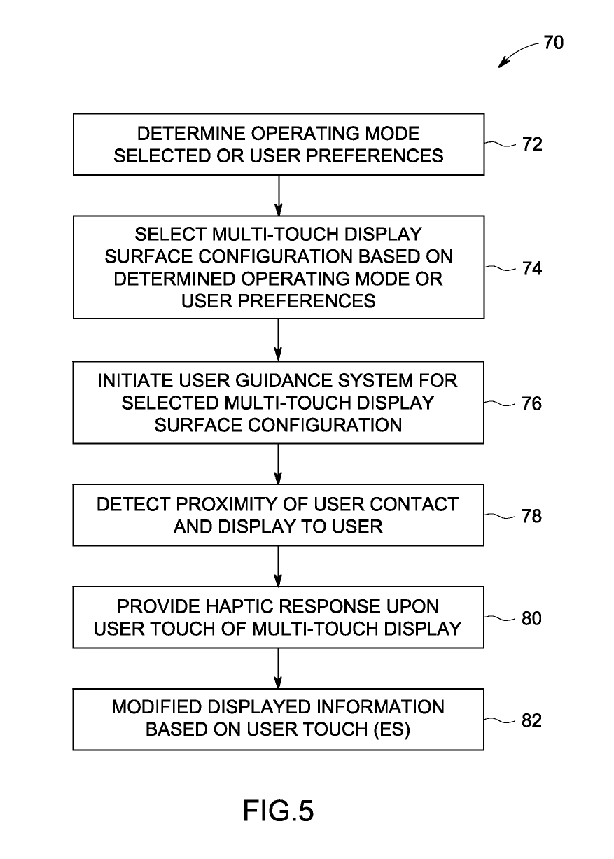

Various embodiments provide a method 70 as illustrated in FIG. 5 for interacting with displayed information using a touch sensitive device or display, for example, the multi-touch screen 38. By practicing the method, review, manipulation and/or creation of datasets may be provided. At least one technical effect of the various embodiments includes maintaining the focus of a user on displayed information while reviewing manipulating and/or creating datasets.

The method 70 allows interaction with datasets (e.g., multi-media datasets) using a graphical multi-touch sensitive device, such as a graphical multi-touch screen interface device with the interaction with the datasets visualized on one or more displays. In various embodiments, the surface of the multi-touch sensitive device and the surface of the one or more displays are different, such as separate devices with separate surfaces or the same device having differently configured surfaces. In particular, the method 70 includes at 72 determining an operating mode, which may be selected by a user, or determining user preferences, such as for a current session or workflow. For example, a determination may be made that a particular review mode has been initiated, which allows a user to perform certain functions and operations on datasets that are realized by certain functionality or operators displayed on a screen (e.g., virtual selectable elements, menu navigation bars, menus, etc.). A multi-touch display surface configuration then may be selected at 74 based on the determined operating mode or user preferences. For example, the screen configuration, such as the windows (e.g., quad display) may define a particular display requirement or size, which is similarly provided on the multi-touch display surface, such as the orientation and position of the various selectable elements displayed on a screen or the display. Additionally, the hard keys or other controls may be configured such that certain actions are associated with corresponding operations to be performed, such as depression of a particular button.

As another example, a user preference may include how the display responds to a particular user action, such as sliding/swiping across the multi-touch display surface or multiple touches of the multi-touch display surface. The display configuration may also initially position display elements based on the user preferences. In some embodiments, the selected multi-touch display surface configuration includes having the information on a monitor or screen display also provided or displayed on the multi-touch display surface.

Thereafter, the user guidance system is initiated at 76 for the selected multi-touch display surface configuration. For example, proximity sensing/visualization and/or haptic sensing may be initiated as described in more detail herein and corresponding to the particular display mode. It should be noted that the user guidance system in some embodiments is only activated when needed or desired (e.g., based on a particular operating mode) or may be activated as long as the system is on. In still other embodiments, the proximity sensing/visualization and/or haptic sensing may be provided in connection with only certain portions of the multi-touch display surface or may be different for different portions of the multi-touch display surface.

The proximity of user contact, for example, the proximity of a user's finger(s) from the multi-touch display surface is detected at 78 and an indication is displayed to the user. For example, as described in more detail herein, a graphical indicator is displayed to a user indicating the area of the screen corresponding to the detected user finger(s). One or more graphical indicators may be provided for each detected finger.

Additionally, a haptic response (e.g., vibrational response) also may be provided at 80 upon a user touching or contacting the multi-touch display surface. The haptic response or haptic feedback may be different based on the portion of the multi-touch display surface touched. For example, depending on the information or object displayed at the area where user contact is made, the haptic response may be different, such as a different intensity, type of response, length of response, etc. Thus, if a user touches the multi-touch display surface at an area corresponding to a displayed virtual button, the haptic response may be more of a sharp or short intense vibration versus a less intense vibration when an image being displayed or menu bar is selected.

The displayed information thereafter may be modified (e.g., moved, reoriented, etc.) based on the user touch(es). For example, objects or windows displayed on the screen may be moved by a corresponding movement of a user's finger on the multi-touch display surface.

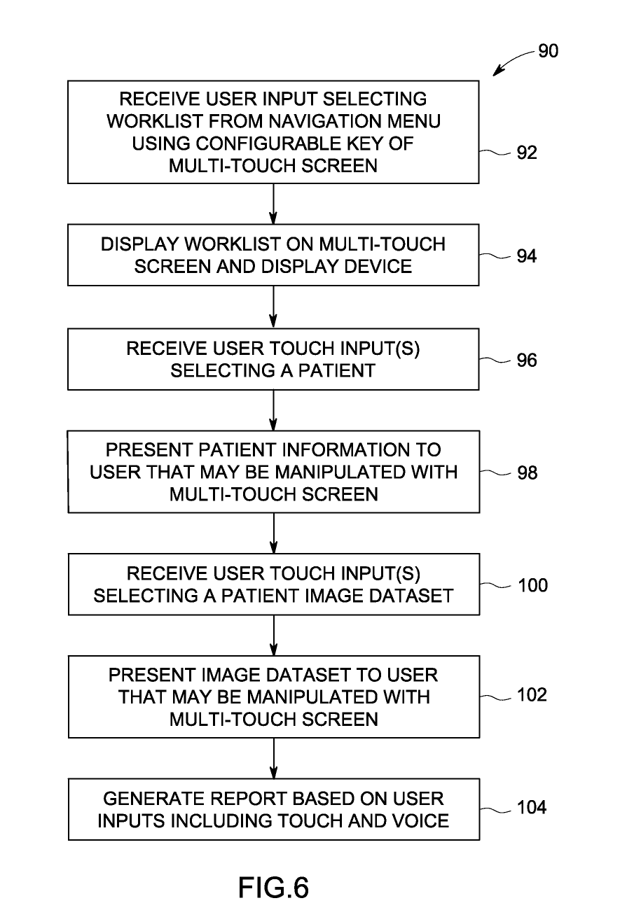

The user interface of various embodiments may be implemented in a diagnostic medical imaging review application, such as by a reviewing radiologist that is reviewing and analyzing medical images. A method 90 for interacting with displayed information using a touch sensitive display, for example, the multi-touch screen 38 in a medical review application is illustrated in FIG. 6. The method includes receiving at 92 a user input selecting a worklist from a navigation menu using one or more displayed virtual keys, which may be configurable as described herein, such as based on the mode of operation or user preferences. It should be noted that a worklist generally refers to any list of work items, action items, review items, etc. to be performed.

The worklist then is displayed at 94 on a screen of the multi-touch display surface, as well as on a screen of a vertical display being viewed by the user. A user is then able to select a patient or worklist item by touching a corresponding location on the multi-touch display surface. Accordingly, at 96 one or more user touch inputs selecting a patient or worklist item are received.

For example, selection of a next patient for review may be triggered in multiple ways depending on the nature of the reading. When the patient needs to be selected from a worklist, the radiologist may select a worklist from a high level navigation, which can be performed using a configurable key of the multi-touch display surface (e.g., a configurable soft key). The worklist is then displayed on both the screen of the multi-touch display surface and the display device(s). A radiologists then uses his or her fingers on the multi-touch display surface to scroll through the worklist and select the patient using touch inputs/gestures and capabilities as described in more detail herein.

Referring again to FIG. 6, thereafter patient information is presented to a user at 98. The patient information may be manipulated with the multi-touch display surface. For example, once the patient or worklist item has been selected, patient information including the referring physician's prescription and relevant patient history may be reviewed either using text to speech or, if reviewed visually, the files may be displayed as thumbnails and opened, positioned on screen and sized using multi-touch gestures.

Thereafter, one or more user touch inputs are received at 100 to select a patient image dataset. For example, continuing with the reviewing radiologist example, the next workflow step is to select the patient image dataset for review, which may be a single dataset (e.g., CT or magnetic resonance (MR) exam) or several datasets awaiting review.

The image dataset is then presented to the user at 102. The image dataset may be manipulated with the multi-touch display surface by one or more touch inputs. For example, once the dataset for review is selected, the dataset may be browsed and reviewed by scrolling (using touch inputs) through a filmstrip type set of thumbnail two-dimensional (2D) image slices, where one of the thumbnails is always shown in a large viewing window or windows when multiple views are needed or desired per slice. When a particular slice needs to be manipulated (e.g., pan, zoom in/out, window level, window width, etc.) or annotated, such operation may be accomplished also using multi-touch gestures in the larger viewing window, where the particular slice(s) are shown enlarged. The multi-touch gestures may be predefined, predetermined or may have to be programmed by a user, for example, during a learning mode of the multi-touch display device wherein the multi-touch gestures are stored and associated with particular operations or functions, such as particular system commands.

A report then may be generated at 104 based on the user inputs, which may include touch, as well as voice inputs. For example, an annotated image then may be copied into a reporting bin by moving the thumbnail into a bin area (with multi-touch gestures) for use in a radiologist report. Once the dataset has been reviewed, radiologists can report the findings using dictation (with voice recognition software), structured reporting or a combination thereof. During the report generation, the annotated images may be displayed as thumbnails and incorporated into the report text if voice recognition software is used to generate the electronic file for the report as the report is being dictated.

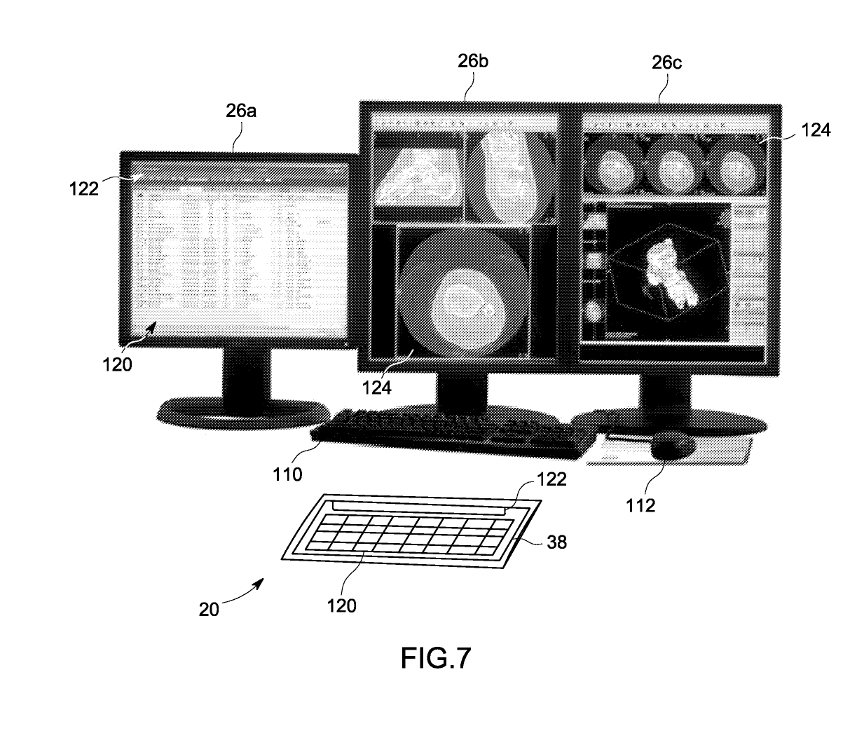

Thus, various embodiments provide for interacting with datasets (e.g., multi-media datasets) using a graphical multi-touch interface device with the interaction with the datasets visualized one or more separate display devices as illustrated in FIGS. 7 through 9. In particular, the interface device, which may be the user interface 20 includes the multi-touch screen 38, as well as a haptic panel 42 and proximity sensor(s) 42 (e.g., a proximity sensing panel), both shown in FIG. 1. Additional user input devices optionally may be provided, for example, a keyboard 110 and/or mouse 112. Additionally, as described in more detail herein, control keys may be provided to configure the functionality of the multi-touch interface device in accordance with the interaction workflow, some of which may be hard keys.

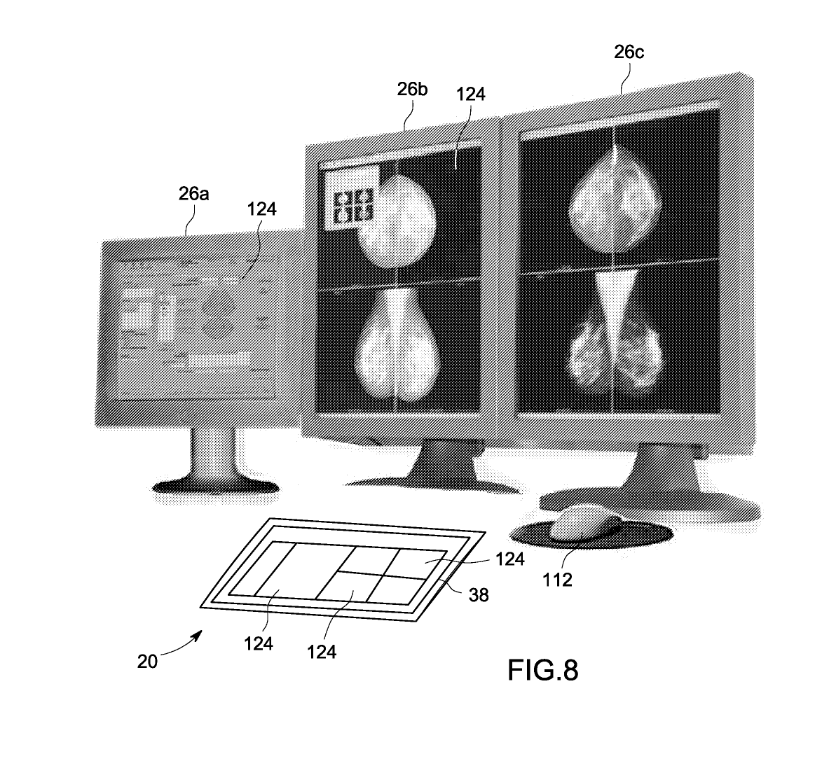

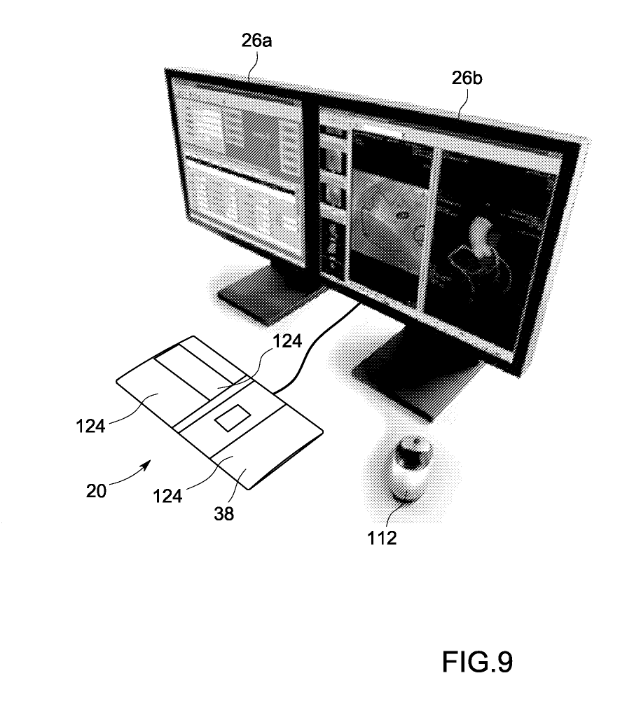

As can be seen in FIGS. 7 through 9, the multi-touch screen interface device may correspond to and be associated with controlling one or more of the displays 26. For example, FIG. 7 illustrates the multi-touch screen 38 controlling the display 26a and having the same or similar information presented or displayed thereon. For example, the worklist 120 and user selectable elements 122 provided on the display to be controlled, namely the display 26a are similarly displayed or associated with the configuration of the multi-touch screen 38. If a user switches to a different display as described in more detail herein, the multi-touch screen 38 also changes. Similarly, FIG. 8 illustrates the multi-touch screen 38 controlling two of the three displays, namely the displays 26a and 26b, and displaying the panels 124 (e.g., virtual windows). FIG. 9 illustrates the multi-touch screen 38 controlling all of the displays, namely displays 26a and 26b.

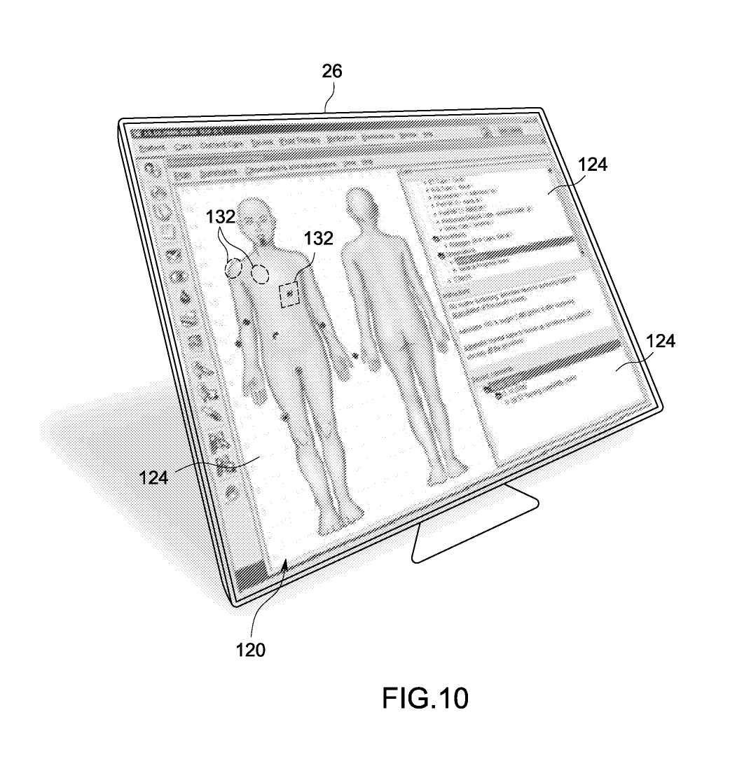

In operation, the interactions may include, for example, browsing the dataset(s); opening a plurality of datasets; selecting, manipulating, annotating and saving a dataset; and creating new datasets. It should be noted that the visualization display devices, namely the displays 26 may be positioned at a different angle and/or visual distance from the illustrated multi-touch screen 38. The interaction includes the display of finger positions on the vertical displays 26 prior to touching the surface of the multi-touch screen 38, utilizing the inputs from the proximity sensors 44 (shown in FIG. 1) as a way to guide the user. Thus, for example, as shown in screen 130 of the display 26 in FIG. 10 having a plurality of panels 124, one or more graphical indicators 132 may be displayed identifying the proximate location or location of a touch of a user's fingers relative to the multi-touch screen 38. In some embodiments, the graphical indicators 132 are about the same size as the portion of the user's fingers that are detected. The graphical indicators 132 may be differently displayed, for example, a colored ring or square depending on whether the user's finger is in proximity to or in contact with, respectively, the multi-touch screen 38. In other embodiments, the graphical indicators 132 may smudge or alter the displayed information.

Additionally, the interaction of the various embodiments includes providing touch sensations to the user that may vary with the type of GUI objects with which the user is interacting. It should be noted that the graphical indicator 132 may be displayed when the user's fingers are in proximity to the multi-touch screen 38 and/or while the user's fingers are touching the multi-touch screen 38.

It also should be noted that although the various embodiments may be described in connection with a particular display configuration or application (e.g., radiological review), the methods and systems are not limited to a particular application or a particular configuration thereof. The various embodiments may be implemented in connection with different types of imaging systems, including, for example, x-ray imaging systems, MRI systems, CT imaging systems, positron emission tomography (PET) imaging systems, or combined imaging systems, among others. Further, the various embodiments may be implemented in non-medical imaging systems, for example, non-destructive testing systems such as ultrasound weld testing systems or airport baggage scanning systems, as well as systems for reviewing multimedia datasets, for example, file editing and production. For example, the various embodiments may be implemented in connection with systems for users that manipulate one or more displayed datasets, such as television and video production and editing, a pilot cockpit, energy plant control systems, among others.

It should be noted that the various embodiments may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a floppy disk drive, optical disk drive, and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), ASICs, logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software and which may be embodied as a tangible and non-transitory computer readable medium. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, the embodiments are by no means limiting and are exemplary embodiments. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A method for interacting with displayed information, the method comprising:
displaying information on a display having a surface viewable by a user;
receiving a user input at a surface of a multi-touch sensitive device, the surface of the multi-touch sensitive device being a different surface than the surface of the display viewable by the user; and
manipulating the displayed information in response to the received user input.

2. A method in accordance with claim 1 further comprising providing guidance responses based on the user input, the guidance responses including at least one of displaying graphical indicators on the display or providing a haptic response with the multi-touch sensitive device.

3. A method in accordance with claim 2 wherein providing the haptic response comprises providing a different haptic response based on a portion of a surface of the multi-touch sensitive device touched.

4. A method in accordance with claim 2 wherein displaying the graphical indicators comprises displaying a plurality of graphical indicators of about a same size as fingers of the user providing the input.

5. A method in accordance with claim 1 further comprising detecting one or more fingers of a user in proximity to the multi-touch sensitive device with at least one proximity sensor and displaying an indicator on the display, wherein the indicator corresponds to a location of the detected fingers relative to the multi-touch sensitive device.

6. A method in accordance with claim 1 wherein manipulating the displayed information comprises modifying the displayed information based on multi-touch gestures received at the multi-touch sensitive device.

7. A method in accordance with claim 1 further comprising associating multi-touch gestures received at the multi-touch sensitive device with a system command.

8. A method in accordance with claim 1 further comprising displaying a worklist on the multi-touch sensitive device and the display, and receiving a user touch input from the multi-touch sensitive display to select an item for display from the worklist.

9. A method in accordance with claim 8 wherein the item corresponds to a patient and further comprising displaying patient information.

10. A method in accordance with claim 8 wherein the item comprises a patient image dataset having one or more images and further comprising opening, positioning on the display and sizing the images based on multi-touch gestures received at the multi-touch sensitive device.

11. A method in accordance with claim 10 wherein the images comprise a set of two-dimensional (2D) image slices and further comprising one of panning, zooming, adjusting a display window or annotating at least one of the 2D image slices based on multi-touch gestures received at the multi-touch sensitive device.

12. A method in accordance with claim 10 further comprising receiving an audible input and generating an electronic report file in combination with at least one of the images.

13. A method in accordance with claim 1 further comprising receiving a user input from an additional non-touch sensitive device.

14. A workstation comprising:
at least one display oriented for viewing by a user and displaying information on a surface of the display;
a multi-touch sensitive device having a screen with a surface location different than the surface of the display, the multi-touch sensitive device configured to detect contact of the screen surface by one or more fingers of a user, the user contact corresponding to a user input; and
a processor configured to manipulate the displayed information in response to the received user input.

15. A workstation in accordance with claim 14 wherein the information displayed on the at least one display is displayed on the multi-touch sensitive device.

16. A workstation in accordance with claim 14 wherein the at least one display is in a generally vertical orientation and the screen of the multi-touch sensitive device is in a generally horizontal orientation.

17. A workstation in accordance with claim 14 further comprising at least one non-touch sensitive user input device.

18. A workstation in accordance with claim 14 further comprising a plurality of displays and wherein the multi-touch sensitive device is configured to receive a user touch input to switch control of the displays using the multi-touch sensitive device.

19. A workstation in accordance with claim 14 wherein the multi-touch sensitive device is configured to receive multi-touch gestures to modify the information displayed on the at least one display.

20. A workstation in accordance with claim 14 wherein the processor is connected to a database having medical image information stored therein, the at least one display is configured to display the medical image information and the multi-touch sensitive device is configured to receive multi-touch gestures for opening, positioning on the display and sizing the medical image information.

21. A workstation in accordance with claim 14 further comprising a haptic panel connected to the multi-touch sensitive device configured to provide a haptic response based on sensing contact with the multi-touch sensitive device and a proximity sensor configured to detect one or more fingers of a user in proximity to the multi-touch sensitive device, and wherein the processor is configured to generate an indicator on the at least one display, the indicator corresponding to a location of the detected fingers relative to the multi-touch sensitive device.

22. A user interface comprising:
a multi-touch sensitive device having an input surface configured to detect user touch inputs; and
a display surface configured to display information for viewing, wherein the input surface and the display surface are not the same surface, and the displayed information is manipulated based on the user touch inputs.
